(19) United States
(12) Patent Application Publication
(10) Pub. No.: US 2020/0364634 A1
(43) Pub. Date: Nov. 19, 2020

(54) SIMON, Supplier Information Management of Network

(71) Applicant: Rachel Ann DePalma, San Jose, CA (US)

(72) Inventor: Rachel Ann DePalma, San Jose, CA (US)

(21) Appl. No.: 16/863,982

(22) Filed: Apr. 30, 2020

Related U.S. Application Data
(60) Provisional application No. 62/849,052, filed on May 16, 2019.

(51) Int. Cl. G06Q 10/06; G06Q 10/08

(52) U.S. Cl. CPC G06Q 10/0633; G06Q 10/087; G06Q 10/0637

(57) ABSTRACT

Supplier Information Management of Network, SIMON. Supplier Management processes, methods and best practices applied to supplier relationship management and supplier performance management.

SIMON is a supplier performance and relationship management “recipe” for impactful and meaningful change is disclosed. By following the recipe, this invention measures both relationships and performance, together providing a checks and balance between perception and data as well as an organizational structure and multi-end user supplier performance review process.

### BACKGROUND OF THE INVENTION

Problem Solved: Managing supplier's performance and relationships with suppliers is complex which is why most sourcing and procurement professional either skip the process or do very little in this space, which leads to loss of current business and leaves companies at a huge disadvantage to be competitive in the market place.

Current supplier performance and relationship management practices only measure part of the process leaving companies vulnerable to blind spots in their supply chain.

By following the recipe, this invention measures both relationships and performance, together providing a checks and balance between perception and data as well as includes a step to close perception gaps between companies and their suppliers.

### DETAILED DESCRIPTION OF THE INVENTION

As stated above, managing supplier's performance and relationships with suppliers is complex which is why most sourcing and procurement professional either skip the process or do very little in this space, which leads to loss of current business and leaves companies at a huge disadvantage to be competitive in the market-place. The invention claimed here solves this problem.

Knowing the right recipe and order of steps to take, removes the complexity of supplier performance and relationship management into smaller parts. Allowing the sourcing and procurement professional to stand up a robust supplier performance and relationship management program in half the time. Less lead time to implementing a process leads to faster results and long-lasting benefits to a company's bottom line.

### The Version of The Invention Discussed Here Includes:

1. Gather performance and relationship information from both internal relationship owners as well as suppliers.
2. Identify trending comments into groups with similar feedback.
3. Identify common data used by the supplier's industry and/or the company to measure supplier performance.
4. Organize the data collected into categories and key performance metrics.
5. Create scorecards.
6. Obtain scorecard measurement buy in from both internal relationship owners as well as suppliers.
7. Clean up current system(s) data to be used in the management of suppliers as identified in steps 1-6.
8. Identify a system to collect supplier management data.
9. Set up system requirements as identified in steps 1-6.
10. Test system, workout the “bugs”.
11. Create end user training program.
12. Launch supplier performance and relationship management process.
13. Collect data.
14. Hold suppler performance reviews, use data collected to share with suppliers and internal stake holders.
15. Manage outcomes from performance reviews.
16. Collaborate with supplier through sharing of ideas and best practices.
17. Continuous improvement cycle for steps to include monitoring of company and industry changes that may affect the outcomes.

### Optional Add-On Features:

A. Perception Gap Analysis, measuring the distance between the survey responses between the end-user and the supplier.
B. Multi-Client supplier performance reviews works best in 3^{rd} party spend management
C. SPM organizational suggestion including roles and responsibilities.

### Relationship Between the Components:

Identify measurements into data buckets specific to the company's industry and product.
1. Gather performance and relationship information from both internal relationship owners as well as suppliers
2. Identify trending comments into groups with similar feedback.
3. Identify common data used by the supplier's industry and/or the company to measure supplier performance.
4. Organize the data collected into categories and key performance metrics.
5. Create scorecards.
6. Obtain scorecard measurement buy in from both internal relationship owners as well as suppliers.

### System Set up.

7. Clean up current system (s) data to be used in the management of suppliers as identified in steps 1-6.
8. Identify a system to collect supplier management data.
9. Set up system requirements as identified in steps 1-6.
10. Test system, workout the “bugs”.
11. Create end user training program.
12. Launch supplier performance and relationship management process.
13. Collect data.
14. Deploy SIMON, BI tool/system. See exhibit A—SIMON.

### Supplier Collaboration.

15. Hold suppler performance reviews, use data collected to share with suppliers and internal stake holders.
16. Manage outcomes from performance reviews.
17. Collaborate with supplier through sharing of ideas and best practices.
18. Continuous improvement cycle for steps to include monitoring of company and industry changes that may affect the outcomes.
   Optional Add-On Features can all be implemented or added as needed to enhance any SPM or SRM program/process.
A. Benchmarking and perception gap analysis, measuring the distance between the survey responses between the end-user and the supplier.
B. Multi end user supplier performance reviews.
C. SPM organizational suggestion including roles and responsibilities.

### How the Invention Works:

The steps can be implemented in stages or as optional steps. However, when implemented together the benefits support a robust supplier performance and relationship program and/or processes.

In order to implement this idea, it is assumed the company has identified key suppliers and or categories critical to the business and product sold as well as a system to deliver the idea and methods. A system can be anything from spreadsheets, online tools to a formal procurement software tool.

### How to Make the Invention:

Plan properly, identify key people like end-users and leadership who will support the process and or program. See exhibit A—SIMON for details.

All the steps can be implemented in stages or as optional steps. However, when implemented together the benefits support a robust supplier performance and relationship program. Elements that could be added make the idea work better, implementing the seven steps to strategic sourcing, doing deep data dives on spend to identify seasonal trends then launching the scorecards (survey and other requirements data gathering) at the right time will provide data that has increased accuracy rates.

Most of the elements can be shuffled around, interchanged or reconfigured to suit any company's needs and still perform in the manner described. Desired results may take longer if implemented out of sequence.

### How to Use the Invention:

Implementing all the elements, over time typically 3-4 measurement cycles supplier performance issues begin to drop off and collaboration replaces the “noise”. Without the elements, what's important to both the company and the supplier is lost in translations usually ending with supplier terminations and negative views for how the company conducts business with their suppliers.

Assigning a program manager would ensure the process developed from implementing the elements is followed as designed. The program manager would be responsible for overseeing supplier performance and relationship management from the design to implementation and continuous improvement process. Depending on the company's organization structure, processes may be owned by others within the organization or even outside of the organization but still with oversight from the program manager.

The elements can be implemented into any industry's supply chain. The elements can be automated, to some extent, to improve the delivery of the process.

Additionally: The elements can be implemented into any industry's supply chain. The elements can be automated, to some extent, to improve the delivery of the process. This process is not specific to any one system or tool used to deliver supplier relationship and performance management.

Also, it can create: (1) Identify measurements into data buckets specific to the company's industry and product supports consistency in measurement between suppliers in the same industry ensuring fair and ethical business practices are adhered to.

(2) System Set up. Sometimes, after current systems are cleaned up, they become useful to the end users. A company may not require additional funding for a new system.
(3) Supplier Collaboration. Collaborative space that fosters growth and innovation between the company and the supplier. Having a collaborative space provides an avenue to implement change easier and faster.

1. The claimed invention differs from what currently exists. This invention closes the gaps of old methods by providing a 360-degree view of all aspects to managing relationships with suppliers.
This invention is an improvement on what currently exists. This invention closes the gaps of old methods by providing a 360-degree view of all aspects to managing relationships with suppliers.
Other methods only focus on one area. For example, measuring performance but not relationships or measuring relationships and not performance. Measuring only relationships is subject to perception gaps and only measuring performance is subject to gaps in data collection errors.
By following the recipe, this invention measures both relationships and performance, together providing a checks and balance between perception and data as well as includes a step to close perception gaps between companies and their suppliers.
The invention also promotes the following benefits:
(1) Identify measurements into data buckets specific to the company's industry and product supports consistency in measurement between suppliers in the same industry ensuring fair and ethical business practices are adhered to.
(2) System Set up. Sometimes, after current systems are cleaned up, they become useful to the end users. A company may not require additional funding for a new system.
(3) Supplier Collaboration. Collaborative space that fosters growth and innovation between the company and the supplier. Having a collaborative space provides an avenue to implement change easier and faster.
